(19) United States
(12) Patent Application Publication
(10) Pub. No.: US 2007/0029177 A1
(43) Pub. Date: Feb. 8, 2007

(54) ELECTRICAL BOX PAINT COVER

(76) Inventor: James Sprague, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 11/462,349

(22) Filed: Aug. 3, 2006

Related U.S. Application Data
(60) Provisional application No. 60/705,526, filed on Aug. 3, 2005.

(51) Int. Cl. H01R 39/00

(52) U.S. Cl. 200/19.38

(57) ABSTRACT

A protective cover for an electrical box of a type having vertical side walls embedded within a wall surface and enclosing a light switch or outlet protruding through an opening of the electrical box and beyond the plane of the wall surface has a rectangular box portion defining a peripheral dimension substantially similar to a dimension of the opening of the electrical box and has a cavity sized to receive the protruding light switch. Flanges extend outward laterally from the rectangular box portion and configured to rest on the wall surface. Further, side extensions coupled to the rectangular box portion and adapted to slidably engage with the vertical side walls of the electrical box to secure the protective cover in place.

### CROSS-REFERENCE TO RELATED APPLICATIONS

This application claims the benefit from U.S. Provisional Patent Application No. 60/705,526 filed Aug. 3, 2005, whose contents are incorporated herein for all purposes.

### BACKGROUND OF THE INVENTION

When painting an interior wall of a building properly, one must first remove the cover plates from the outlets and light switches. Once exposed, however, the outlet and light switch electrical boxes are prone to paint splatter or sloppy painting. The conventional solution is to use tape to cover these box openings. The tape solution has a major drawback in that it can leave jagged edges when the tape is removed from the wall and it is difficult to put tape over protruding light switches.

What is needed is a simple way to protect light switches and outlets during painting or other maintenance procedures that can be easily installed and removed and leaves a clean paint edge when removed.

### SUMMARY OF THE INVENTION

The present idea solves that problem by simply sliding the side extensions into the electrical box that fit snugly against the inside sidewalls of the electrical box. The rectangular cover is sized to have a cavity large enough to receive a light switch or outlet. The flanges extend outward laterally from rectangular box along the wall forming a rectangular covering over the wall that is slightly smaller than the standard light switch or outlet cover.

### BRIEF DESCRIPTION OF THE DRAWINGS

FIG. 1 is perspective view of a wall, light switch, electrical box and a paint cover.

FIG. 2 is a cross-sectional view of the wall, light switch, electrical box and the paint cover of FIG. 1 taken along line 2-2 in FIG. 1.

### DETAILED DESCRIPTION

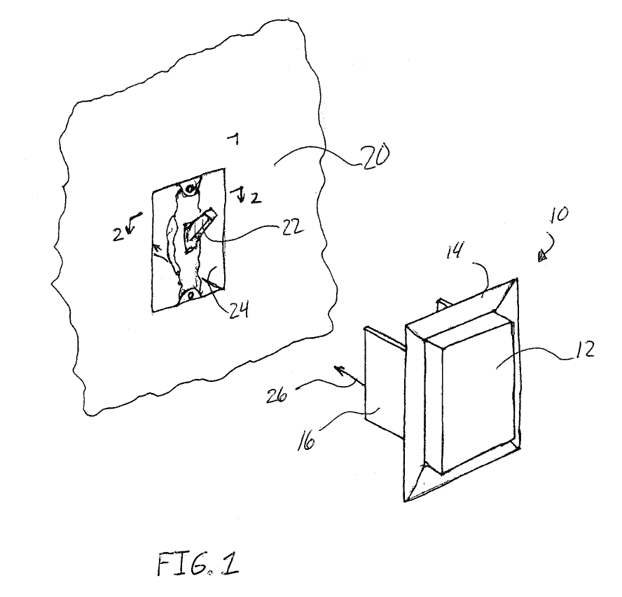

FIG. 1 is a perspective view of a paint cover 10 showing a rectangular box portion 12, the flanges 14 and side extensions 16. The dimensions shown are for use with a standard single light switch or outlet electrical box. A standard single switch/outlet cover is 4½″ tall and 2¾″ wide, but it is contemplated that other sizes can be used to cover double and triple light switch and outlet boxes. The rectangular box portion 12 forms a cavity shown to be ¾ inch deep so as to allow for the protrusion of a light switch while still having flanges 14 contact the wall around the electrical box. A wall 20, light switch 22, and electrical box 24 are shown. Arrow 26 shows how the paint cover 10 is inserted into the electrical box 24.

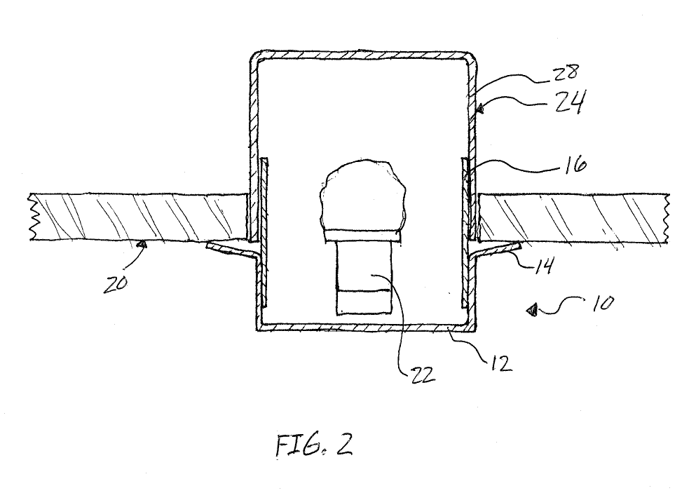

FIG. 2 is a cross-sectional view of the paint cover 10 inserted into the electrical box 24 taken along line 2-2 in FIG. 1. The side extensions 16 fit snugly against the inside of the vertical side walls 28 of electrical box 24 without interfering with the light switch 22. The rectangular box portion 12 has a cavity sized to receive the protruding light switch 22 when the flanges 14 contact the wall 20. A person can then paint the wall 20 without getting paint on the light switch 22 and, when finished, easily and quickly remove the paint cover 10.

It is to be understood that the above-referenced arrangements are only illustrative of the application for the principles of the present invention. Numerous modifications and alternative arrangements can be devised without departing from the spirit and scope of the present disclosure. While embodiments of the present invention have been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts as set forth herein. I claim all modifications and variation coming within the spirit and scope of the following claims.

What is claimed is:

1. A protective cover for an electrical box of a type having vertical side walls embedded within a wall surface and enclosing a light switch or outlet protruding through an opening of the electrical box and beyond the plane of the wall surface, the protective cover comprising:
a rectangular box portion defining a peripheral dimension substantially similar to a dimension of the opening of the electrical box and having a cavity sized to receive the protruding light switch;
flanges extending outward laterally from the rectangular box portion and configured to rest on the wall surface; and
side extensions coupled to the rectangular box portion and adapted to slidably engage with the vertical side walls of the electrical box to secure the protective cover in place.

2. The protective cover of claim 1 wherein the rectangular box portion is sized to cover electrical boxes configured to house multiple electrical outlets and switches.

3. A method of using a protective cover to cover an electrical box embedded within a wall surface while painting the wall, said method comprising the steps of:
removing a standard-sized electrical box cover;
providing a protective cover configured to slidably couple into the electrical box;
sliding the protective cover into the electrical box;
painting the wall surface up to the edge of the protective cover;
removing the protective cover; and
replacing the standard-sized electrical box cover.

4. The method of claim 3 wherein the step of providing a protective cover includes providing a protective cover having a cover portion having a top surface and a bottom surface, a flange extending from the periphery of the cover portion, and a plurality of extensions connected to the bottom surface of the cover portion; and wherein the step of sliding the protective cover into the electrical box includes sliding the extensions into the electrical box.

5. A method for creating a temporary cover for an electrical box to be used in place of a standard cover during painting and maintenance tasks, said method comprising the steps of:
forming a cover portion with a flange to contact a wall surface; and
connecting a plurality of extensions to the cover portion, wherein the extensions can slidably engage the electrical box and to secure the temporary cover in place.

6. The method of claim 5 wherein the cover portion is sized to cover electrical boxes configured to house multiple electrical outlets and switches.

7. The method of claim 5 wherein the step of forming the cover portion includes forming the cover portion in a rectangular shape.
